(19) United States
(12) Patent Application Publication
(10) Pub. No.: US 2025/0126655 A1
(43) Pub. Date: Apr. 17, 2025

(54) NETWORK-ASSISTED CELL SELECTION FOR 2-STEP RANDOM ACCESS PROCEDURES

(71) Applicant: Lenovo (Singapore) Pte Limited, Singapore (SG)

(72) Inventor: Hyejung JUNG, Palatine, IL (US)

(21) Appl. No.: 18/910,893

(22) Filed: Oct. 9, 2024

Related U.S. Application Data
(60) Provisional application No. 63/589,405, filed on Oct. 11, 2023.

(51) Int. Cl. H04W 74/0833; H04W 74/00

(52) U.S. Cl. CPC H04W 74/0833; H04W 74/006

(57) ABSTRACT

Various aspects of the present disclosure relate to network-assisted cell selection. In some embodiments, a network employs a cell within a location to coordinate access between the UE and other cells (e.g., neighbor cells) that are candidates to be a serving cell for the UE within the location but may be in an energy saving state of operation when a UE initiates an access procedure.

### CROSS REFERENCE TO RELATED APPLICATIONS

This application claims priority to U.S. Provisional Patent Application No. 63/589,405, filed on Oct. 11, 2023, entitled NETWORK-ASSISTED CELL SELECTION FOR 2-STEP RANDOM ACCESS PROCEDURES, which is hereby incorporated by reference in its entirety.

### TECHNICAL FIELD

The present disclosure relates to wireless communications, and more specifically to network-assisted cell selection for random access procedures.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In some cases, a geographical location may include a radio access network (RAN) having many base stations (or cells or network nodes), deployed in the location. For example, a location may include many cells (e.g., small cells, distributed multiple input multiple output (MIMO)), densely deployed, to boost a capacity of the location, to reduce or mitigate signal blockage issues, and so on.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that facilitate the access of cells in an energy saving or idle state by a UE during access procedures. For example, a RAN may employ one cell within the location to coordinate access between the UE and other cells (e.g., neighbor cells) that are candidates to be a serving cell for the UE within the location but may be in an energy saving state of operation when a UE initiates an access procedure.

Some implementations of the method and apparatuses described herein may further include a UE comprising a processor and a memory coupled with the processor, the processor configured to cause the UE to transmit a physical random access channel (PRACH) preamble on a PRACH occasion of a first cell and a corresponding message A (MsgA) physical uplink shared channel (PUSCH) on a MsgA PUSCH occasion of the first cell, receive a message B (MsgB) that includes a random access response, identify a serving cell based on receiving the MsgB, and transmit a connection complete message to the identified serving cell.

In some implementations of the method and apparatuses described herein, the connection complete message is a connection setup complete message or a connection resume complete message.

In some implementations of the method and apparatuses described herein, the processor is further configured to cause the UE to detect the first cell, select the first cell, and monitor system information of the first cell.

In some implementations of the method and apparatuses described herein, the serving cell is different from the first cell and transitions from an energy saving state of operation to an active state of operation.

In some implementations of the method and apparatuses described herein, the processor is further configured to cause the UE to perform cell detection for the serving cell when the serving cell is different from the first cell.

In some implementations of the method and apparatuses described herein, the processor is further configured to cause the UE to receive a configuration of multiple common physical downlink control channel (PDCCH) search spaces, wherein each common PDCCH search space is associated with at least one cell from the first cell and one or more neighbor cells of the first cell.

In some implementations of the method and apparatuses described herein, the processor is further configured to cause the UE to monitor the multiple common PDCCH search spaces to receive the MsgB, and identify the serving cell based on detecting downlink control information (DCI) for MsgB delivery in a common PDCCH search space of the multiple common PDCCH search spaces.

In some implementations of the method and apparatuses described herein, the processor is further configured to cause the UE to monitor a first common PDCCH search space of the multiple common PDCCH search spaces that is associated with the first cell.

In some implementations of the method and apparatuses described herein, the UE identifies the first cell as the serving cell when the MsgB does not include an indication of the serving cell corresponding to the random access response, and the UE identifies a second cell different from the first cell as the serving cell when the MsgB includes an indication of the second cell as the serving cell corresponding to the random access response.

In some implementations of the method and apparatuses described herein, the indication of the second cell as the serving cell is included in a medium access control (MAC) subheader of a MAC sub packet data unit (subPDU) for the random access response.

In some implementations of the method and apparatuses described herein, the processor is further configured to cause the UE to monitor a common PDCCH search space associated with the serving cell upon identifying the serving cell, and receive, within the monitored common PDCCH search space, an uplink grant to transmit the connection complete message.

In some implementations of the method and apparatuses described herein, the multiple PDCCH search spaces are quasi co-located with a synchronization signal block (SSB), wherein the SSB is selected for the PRACH preamble transmission on the PRACH occasion of the first cell.

In some implementations of the method and apparatuses described herein, the first cell and the one or more neighbor cells are deployed in a same frequency layer.

In some implementations of the method and apparatuses described herein, the first cell and the one or more neighbor cells are deployed in different frequency layers.

In some implementations of the method and apparatuses described herein, the random access response included in the MsgB is a success random access response (successRAR).

In some implementations of the method and apparatuses described herein, when the random access response included in the MsgB is a fallback random access response (fallbackRAR) and the MsgB includes an indication of one or more candidate serving cells corresponding to the fallbackRAR, the processor is further configured to cause the UE to transmit a message 3 (Msg3) with a measurement report for the one or more candidate serving cells, receive a message 4 (Msg4), and identify the serving cell based on the reception of the MsgB and the Msg4.

Some implementations of the method and apparatuses described herein may further include a processor for wireless communication comprising at least one controller coupled with at least one memory and configured to cause the processor to transmit a PRACH preamble on a PRACH occasion of a first cell and a corresponding message A (MsgA) PUSCH on a MsgA PUSCH occasion of the first cell, receive a message B (MsgB) that includes a random access response, identify a serving cell based on receiving the MsgB, and transmit a connection complete message to the identified serving cell.

Some implementations of the method and apparatuses described herein may further include a method performed by a UE the method comprising transmitting a PRACH preamble on a PRACH occasion of a first cell and a corresponding message A (MsgA) PUSCH on a MsgA PUSCH occasion of the first cell, receiving a message B (MsgB) that includes a random access response, identifying a serving cell based on receiving the MsgB, and transmitting a connection complete message to the identified serving cell.

Some implementations of the method and apparatuses described herein may further include a network entity, comprising a processor and a memory coupled with the processor, the processor configured to cause the network entity to receive, from a UE, a PRACH preamble on a PRACH occasion of a first cell and a corresponding message A (MsgA) PUSCH on a MsgA PUSCH occasion of the first cell, and transmit a message B (MsgB) that includes a random access response, wherein delivery of the MsgB identifies a neighbor cell of the first cell as a serving cell for the UE.

In some implementations of the method and apparatuses described herein, the neighbor cell transitions from an energy saving state of operation to an active state of operation.

In some implementations of the method and apparatuses described herein, a common physical downlink control channel (PDCCH) search space that includes downlink control information (DCI) for the delivery of the MsgB identifies the neighbor cell of the first cell as the serving cell for the UE.

### BRIEF DESCRIPTION OF THE DRAWINGS

FIG. 1 illustrates an example of a wireless communications system in accordance with aspects of the present disclosure.

FIG. 2 illustrates an example of multiple cells deployed at a location in accordance with aspects of the present disclosure.

FIG. 3 illustrates an example messaging flow for RAN-assisted cell selection and cell access procedure with 4-step random access in accordance with aspects of the present disclosure.

FIGS. 4A-4C illustrate example medium access channel (MAC) subheader types in accordance with aspects of the present disclosure.

FIG. 5 illustrates an example message MAC Protocol Data Unit (PDU) with Physical Cell Identities (PCIs) in accordance with aspects of the present disclosure.

FIG. 6 illustrates an example messaging flow for RAN-assisted cell selection and cell access procedure with 2-step random access in accordance with aspects of the present disclosure.

FIGS. 7A-7E illustrate example medium access channel (MAC) subheader types in accordance with aspects of the present disclosure.

FIG. 8 illustrates an example message MAC Protocol Data Unit (PDU) with Physical Cell Identities (PCIs) in accordance with aspects of the present disclosure.

FIG. 9 illustrates an example of a user equipment (UE) in accordance with aspects of the present disclosure.

FIG. 10 illustrates an example of a processor in accordance with aspects of the present disclosure.

FIG. 11 illustrates an example of a network equipment (NE) in accordance with aspects of the present disclosure.

FIG. 12 illustrates a flowchart of a method performed by a UE in accordance with aspects of the present disclosure.

FIG. 13 illustrates a flowchart of a method performed by a NE in accordance with aspects of the present disclosure.

### DETAILED DESCRIPTION

When an area or location contains many cells deployed by a RAN, a UE may perform frequent cell selection or re-selection procedures, such as synchronization and acquisition of essential system information while being in an idle or inactive mode. Frequent cell selection procedures can lead to an increased or undesirable power consumption at the UE, among other drawbacks.

Further, the network may manage the deployed cells in ways that reduce energy consumption and/or operational expenses. The network may manage the cells using network energy saving procedures, such as procedures that transition cells between active states of operation (e.g., when a cell is actively transmitting common channels or signals) and energy saving states of operation (e.g., when a cell is infrequently transmitting common channels or signals).

In such cases, a UE seeking access to a network may not be able to utilize cells in a location that are in energy saving states of operation. The technology described herein, therefore, introduces enhanced access procedures that facilitate the access of cells in an energy saving state by a UE during access procedures. For example, the network may employ one cell within the location to coordinate access between the UE and other cells (e.g., neighbor cells) that are candidates to be a serving cell for the UE within the location but may be in an energy saving state of operation when a UE initiates an access procedure.

Thus, the network, via the cells or other network entities, may balance energy savings and reduced power consumption with enhanced cell access for locations with a dense deployment of cells (e.g., many cells deployed by a 6G wireless network), among other benefits.

For example, the network can selectively control (e.g., turn on/off) SSB/SIB 1 transmission of small cells within a location and reduce the energy burden on the UE caused by frequently searching for candidate serving cells. Further, cells in an energy saving state may monitor RACH occasions of other cells (e.g., normal cells in an active state), and thus the UE may not transmit separate PRACH preambles or uplink signals to wake up cells in the energy saving state. Also, rejection or preemption rates during RRC setup may be reduced because a network can consider multiple cells when receiving setup requests.

Aspects of the present disclosure are described in the context of a wireless communications system.

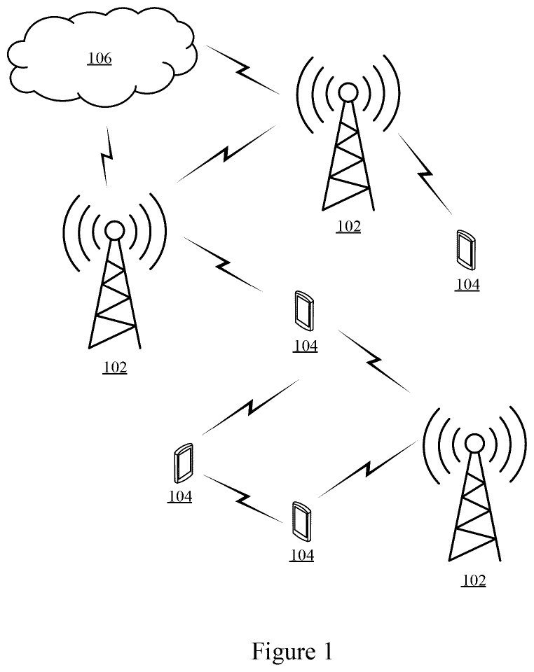

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, p=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology provides enhances access procedures to a UE when the UE accesses a wireless network at a location containing a dense deployment of cells, such as a location where the UE is within the range of multiple available or candidate serving cells (e.g., multiple potential serving cells).

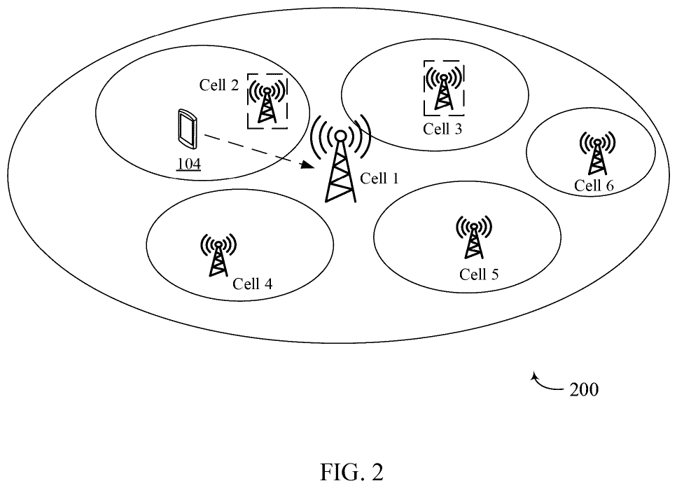

FIG. 2 illustrates an example of multiple cells deployed at a location 200 in accordance with aspects of the present disclosure. Multiple small cells (e.g., cell 2, cell 3, cell 4, cell 5, and cell 6) are deployed under a macro cell (e.g., cell 1). Cell 2 and cell 3 operate in a dormant mode or energy saving state of operation, and do not transmit synchronization signals and/or system information. Cell 4, cell 5, and cell 6 are in an active mode of operation.

Two random access channel (RACH) groups are configured, where both cell 1 and cell 2 monitor a first RACH group (e.g., RACH group 1), and cell 1 and cell 3 monitor a second RACH group (e.g., RACH group 2). Each RACH group is associated with a subset of SSBs of cell 1. Thus, when the UE 104 selects RACH group 1 to perform a random access procedure in cell 1, both cell 1 and cell 2 are candidate serving cells for the UE 104. Similarly, when the UE 104 selects RACH group 2 to perform a random access procedure in cell 1, both cell 1 and cell 3 are candidate serving cells for the UE 104.

In some embodiments, a RACH group configuration of a cell indicates an associated subset of SSBs of the cell and associated one or more neighbor cells to the UE 104. In some embodiments, a RACH group configuration of a cell only indicates an associated subset of SSBs of the cell without indicating one or more associated neighbor cells.

As shown, the UE 104 performs the cell selection/re-selection procedure and selected cell 1. The UE 104 monitors system information and paging information. Once the UE 104 receives a paging message, the UE 104 performs network-assisted cell detection and cell access procedure, as follows.

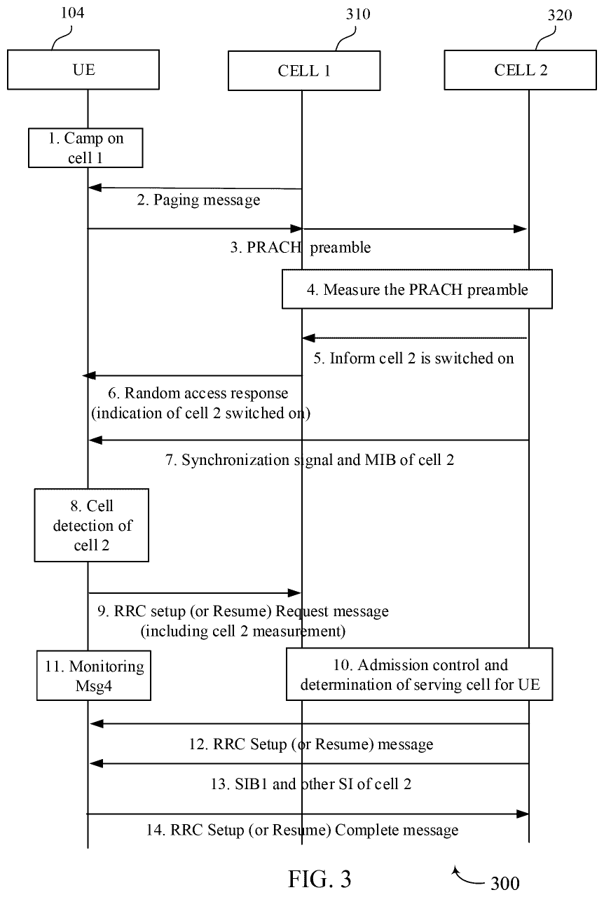

FIG. 3 illustrates an example messaging flow 300 for RAN-assisted cell selection and cell access procedure with 4-step random access in accordance with aspects of the present disclosure. In step 1, the UE 104 camps on a first cell 310 (e.g., cell 1) of a RAN. For example, the UE 104 may have completed a cell selection or re-selection procedure and is monitoring system information and/or paging information, such as in step 2, from the first cell.

In step 3, the UE sends or transmits a PRACH preamble on a random access resource of the first cell 310 to set up (or resume) a connection with the network. Multiple cells, including the first cell 310 and other cells, such as a dormant second cell 320 (e.g., cell 2), monitor the random access resource of the first cell 320. In some cases, the multiple cells are deployed on a same frequency layer. In some cases, the multiple cells are deployed in different frequency layers of different frequency bands. In some cases, the multiple cells are deployed in a same frequency band but in different frequency layers.

Both the first cell 310 and the second cell 320 detect the PRACH preamble of the random access resource of the first cell 310. In step 4, the second cell 320 measures the power of the PRACH preamble. Based on the measured power of the PRACH preamble and/or other factors, the RAN determine whether to switch on the second cell 320 for transmission (e.g., modify the state of operation from an energy saving state to an active state). When the second cell 320 is switched on, the second cell 320, in step 5, informs the first cell 310 that the second cell 320 is in the active state.

Once the first cell 310 is informed that the second cell 320 has been switched on and is in an active mode, the first cell 310, in step 6, transmits a random access response (e.g., a message 2, or Msg2) to the UE 104, which includes an indication that the second cell 320 has been switched on or is being switched on.

After receiving and decoding the Msg2, the UE 104, in steps 7 and 8, detects a synchronization signal (SS) or discovery signal transmitted by the second cell 320, now operating in an active mode and transmitting information. In some cases, the UE 104, in step 7, may also receive a physical broadcast channel (PBCH) of the second cell 320 and/or compact essential system information (e.g., system information block 0 (SIB0), master information blocks (MIBs).

In step 9, the UE 104 transmits a message 3 (e.g., Msg3), which includes a radio resource control (RRC) setup (or resume) request in the first cell 310. The Msg3 may also include a measurement report of the second cell 320 and/or a measurement report for both cells.

The UE 104 may generate and transmit the measurement report for the second cell 320 when the second cell measurement satisfies a predetermined condition (e.g., a configured threshold value). For example, the UE 104 may transmit the measurement report for the second cell 320 when the measurement value for the second cell 320 is at least X dB, is larger than a measurement value for the first cell 310, when the measurement value for the first cell 310 is below a threshold value and the measurement value for the second cell 320 is above the threshold value, and/or other conditions.

The measurement report, in some cases, includes at least one reference signal index/identity (e.g., a SSB index, a channel state information reference signal (CSI-RS) identity, and so on). The measurement report may also include a layer-1 (L1) reference signal received power (RSRP) value for the second cell 320.

In step 10, the RAN determines or selects a serving cell for the UE 104 (e.g., selects the first cell 310 or the second cell 320). The RAN may select the serving cell based on many factors, including: the first cell measurement value, the second cell measurement value, admission controls, such as a connection establishment cause included in Msg3, allocation and retention priority (ARP), a quality of service (QOS) identifier, configured network slices in each of the first and second cells, and so on.

The UE 104, in step 11, monitors for Msg4. After determining the serving cell for the UE 104, the RAN, via the second cell 320, transmits, in step 12, an indication of the selected serving cell to the UE 104 via message 4 (Msg4). Msg4 includes an RRC Setup (or Resume) message, which is received by the UE 104. The UE, via the Msg4, identifies the serving cell (e.g., the second cell 320).

In step 13, the UE 104 also receives system information for the serving cell if such information was not yet acquired by the UE 104. For example, the UE 104 may monitor a physical downlink control channel (PDCCH) search space associated with the first cell 310 and the second cell 320, where a corresponding PDCCH control resource set (CORESET) is quasi-located with a first SSB of the first cell 310 selected for the PRACH preamble transmission.

In some cases, the PDCCH CORESET may be quasi-located with both the first SSB of the first cell 310 and a second SSB of the second cell 320 reported in Msg3. For example, downlink control information (DCI) for Msg4 delivery may include an indication of the serving cell for the UE 104. As another example, physical downlink shared channel (PDSCH) for Msg4 delivery (e.g., a PDSCH payload and/or a PDSCH demodulation reference signal (DM RS)) can include an indication of the serving cell.

In some cases, the UE 104 monitors both a first PDCCH search space associated with the first cell 310 and a second PDCCH search space associated with the second 320, and identifies the serving cell based on detecting a DCI format for Msg4 delivery in one of the PDCCH search spaces.

In step 14, the UE 104 transmits an RRC Setup (or Resume) Complete message to the identified serving cell (e.g., to the second cell 320).

In some embodiments, the Msg2 (see step 6) of the first cell 310 includes one or more physical cell identities (PCIs), which correspond to one or more neighbor cells that are potential or future serving cells for the UE 104. Msg2 may implicitly or explicitly indicate an association between the PCIs and detected PRACH preambles. Alternatively, system information of the first cell 310 may provide a list of neighbor cell identities and corresponding cell indices. The Msg2 of the first cell 310 includes one or more cell indices, which identify one or more neighbor cells that are potential serving cells for the UE 104.

Upon receiving an indication of a PRACH preamble and associated PCI in Msg2, the UE 104 may perform cell detection for neighbor cells that correspond to the PCI. The neighbor cells of the first cell (e.g., cell 3 or cell 2 of FIG. 2) may monitor RACH occasions of the first cell. The RAN may determine a set of neighbor cells to turn on based on (or partially based on) the measurements of the RACH occasions and provide an indication of the determined set of neighbor cells in the Msg2.

The neighbor cells that may be potential serving cells for the UE 104 may be dependent on the location and/or orientation of the UE 104. Thus, the RAN may indicate different PCIs for different PRACH preambles, based in part on the preamble measurements.

In some embodiments, a medium access control (MAC) protocol data unit (PDU) for random access response (RAR) can include a MAC subheader with a PCI of a cell to indicate the cell being turned on. For example, if a MAC subheader with a PCI is followed by another MAC subheader with another PCI, a cell indicated by the PCI is associated with all the PRACH preambles indicated in Msg2.

As another example, if a MAC subheader with a PCI is followed by one or more consecutive MAC subPDUs for RAR (e.g., each MAC subPDU including a MAC subheader with a random access preamble identifier (RAPID) and a MAC RAR), a cell indicated by the PCI is associated with a set of PRACH preambles indicated by the one or more consecutive MAC subPDUs for RAR.

When the UE 104 identifies a transmitted PRACH preamble among one or more MAC subPDUs for RAR, and further identifies a neighbor cell associated with the transmitted RA preamble, the UE 104 performs cell detection for the neighbor cell. However, when Msg2 does not include a MAC subPDU for RAR, but includes a MAC subheader with a PCI, the UE 104, upon successfully decoding the Msg2, performs cell detection for a neighbor cell indicated by the PCI and may re-select to the neighbor cell based on cell measurements.

As an example, a MAC subheader (octet aligned) for Msg2 includes one or more of the following fields:

E: The Extension field is a flag indicating if the MAC subPDU including this MAC subheader is the last MAC subPDU or not in the MAC PDU. The E field is set to 1 to indicate at least another MAC subPDU follows. The E field is set to 0 to indicate that the MAC subPDU including this MAC subheader is the last MAC subPDU in the MAC PDU;

T1: The Type1 field is a flag indicating whether the MAC subheader contains a Random Access Preamble ID or a Backoff Indicator/a Physical Cell Identity. The T1 field is set to 0 to indicate the presence of a Backoff Indicator field or the presence of a Physical Cell Identity field in the subheader (BI/PCI). The T1 field is set to 1 to indicate the presence of a Random Access Preamble ID field in the subheader (RAPID);

T2: The Type2 field is a flag indicating whether the MAC subheader contains a Backoff Indicator or a Physical Cell Identity. The T2 field is set to 0 to indicate the presence of a Backoff Indicator field (BI) in the subheader. The T2 field is set to 1 to indicate the presence of a Physical Cell Identity field (PCI) in the subheader;

R: Reserved bit, set to 0;

BI: The Backoff Indicator field identifies the overload condition in the cell. The size of the BI field is 4 bits;

PCI: The Physical Cell Identity field identifies a neighbor cell assigned as a candidate serving cell. The size of the PCI field is 10 bits; and/or

RAPID: The Random Access Preamble IDentifier field identifies the transmitted Random Access Preamble. The size of the RAPID field is 6 bits. If the RAPID in the MAC subheader of a MAC subPDU corresponds to one of the Random Access Preambles configured for system information (SI) request, MAC RAR is not included in the MAC subPDU.

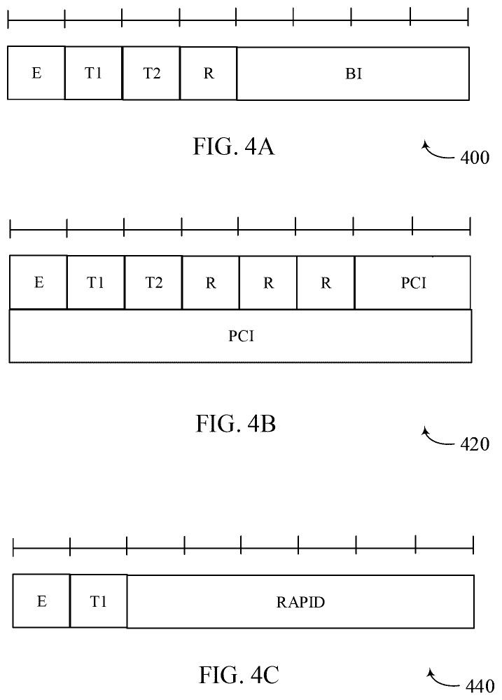

FIGS. 4A-4C illustrate example medium access channel (MAC) subheader types in accordance with aspects of the present disclosure. For example, FIG. 4A depicts an E/T1/T2/R/BI MAC subheader 400, which is a MAC subheader with Backoff Indicator only. The subheader 400, in some cases, may only be placed at a beginning of a MAC PDU, when included.

As another example, FIG. 4B depicts an E/T1/T2/R/PCI MAC subheader 420, which is a MAC subheader with PCI only. As a further example, FIG. 4C depicts an E/T1/RAPID MAC subheader 440, which is a MAC subheader with RAPID and MAC RAR. The subheaders 420 and 440, in some cases, may be placed anywhere between the subheader 400 and padding. Padding may be placed at the end of the MAC PDU, and its presence and/or length may be based on a transport block (TB) size, a size of the MAC subPDUs, and so on.

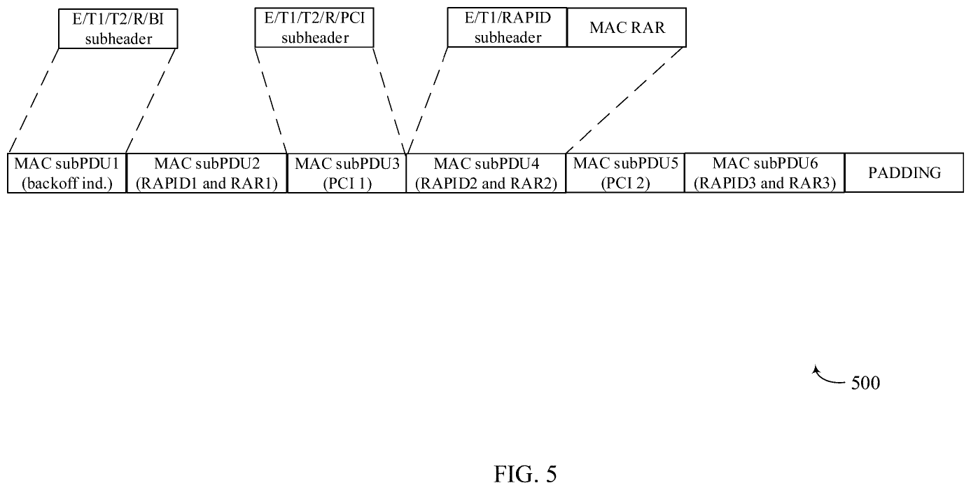

FIG. 5 illustrates an example message MAC Protocol Data Unit (PDU) with Physical Cell Identities (PCIs) 500 in accordance with aspects of the present disclosure. When the UE 104 transmits a PRACH preamble with RAPID 1, the UE 104 assumes no neighbor cell is associated with RAPID 1. When the UE 104 transmits a PRACH preamble with RAPID 2, the UE 104 assumes that a cell associated with PCI 1 is a candidate neighbor cell and performs cell detection and measurement for the cell associated with PCI 1. When the UE 104 transmits a PRACH preamble of RAPID 3, the UE 104 assumes that a cell of PCI 2 is a candidate neighbor cell and performs cell detection and measurement for the cell associated with PCI 2.

In some embodiments, an L1 neighbor cell measurement report is included in a Msg3 transport block as an L1 payload. In some cases, the measurement report is included in an RRC message (e.g., an RRC setup or resume request message).

In some embodiments, the UE 104 is configured with two cell-specific sets of time domain resource allocation (TDRA) configurations and/or refers to two predefined (e.g., default) sets of TDRA configurations for a given cyclic prefix (CP) type for Msg3 physical uplink shared channel (PUSCH). When the UE 104 identifies a transmitted PRACH preamble and a neighbor cell associated with the transmitted PRACH preamble in Msg2, the UE 104 uses a first set of TDRA configurations for Msg3 PUSCH transmission.

When the UE 104 does not identify a neighbor cell associated with the transmitted PRACH preamble but identifies the transmitted PRACH preamble in Msg2, the UE 104 uses a second set of TDRA configurations for Msg3 PUSCH transmission. In some cases, the first set of TDRA configurations includes a larger time offset between a slot/symbol where an uplink grant for Msg3 PUSCH is received and a slot/symbol where the Msg3 PUSCH is transmitted. When the UE 104 performs cell detection and measurement on the neighbor cell and includes a L1 measurement report into Msg3 PUSCH, the larger time offset may provide the UE 104 with more processing time for cell detection and measurement.

In some embodiments, a UE 104 is configured with multiple PDCCH search spaces (or receives an indication of multiple common PDCCH search spaces in system information), where each of the multiple PDCCH search spaces is associated with at least one candidate cell, in order to receive Msg4 reception from a switched on neighbor cell.

In some embodiments, when a RAN turns on an energy saving neighbor cell for transmission and assigns the neighbor cell as a serving cell for a UE that sent an access request to a non-energy saving cell, Msg4 PDSCH may include an uplink timing advance (TA) adjustment command. The UE may perform subsequent uplink transmission (e.g., sending a RRC setup (or resume) complete message) to the assigned serving cell based on a TA command received in Msg2 and the TA adjustment command received in Msg4.

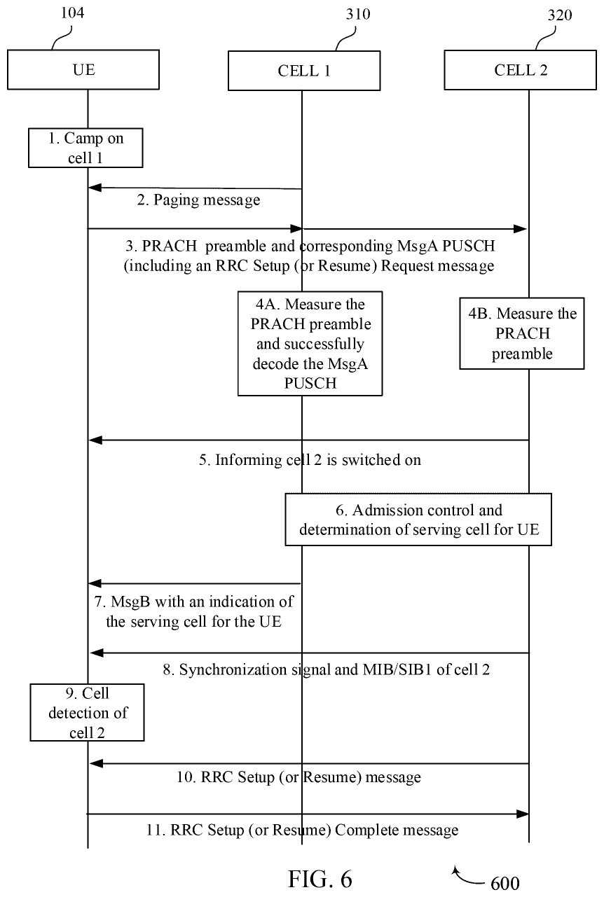

As described herein, in addition to the 4-step random access procedure, the technology may be employed during 2-step random access. FIG. 6 illustrates an example messaging flow 600 for RAN-assisted cell selection and cell access procedure with 2-step random access in accordance with aspects of the present disclosure.

In step 1, the UE 104 camps on the first cell 310 of the RAN. The UE 104, upon receiving a paging message (see step 2), transmits, in step 3, a PRACH preamble and a message A (MsgA) PUSCH on a 2-step random access resource of the first cell 310, to set up (or resume) a connection with the network.

The MsgA PUSCH carries a RRC setup (or resume) request message. Multiple cells, including the first cell 310 and the second cell 320 monitor the random access resource of the first cell 310. As described herein, the multiple cells may be deployed in a same frequency layer, in different frequency layers of different frequency bands, and/or in a same frequency band but in different frequency layers.

Both the first cell 310 and the second cell 320 detect the PRACH preamble on the random access resource of the first cell 310. The second cell 320, in step 4B, measures a received PRACH preamble power. The RAN determines whether to turn on the second cell 320 for transmission based, in part, on the measured received random access preamble power.

In step 4A, the first cell 310 successfully decodes the MsgA PUSCH. The RAN decides to turn on the second cell for transmission, and, in step 5, transmits an indication to the UE 104. The RAN, in step 6, determines a serving cell for the UE 104 between the first cell 310 and the second cell 320 based on one or more of the following conditions: a first PRACH preamble measurement value by the first cell 310, a second PRACH preamble measurement value by the second cell 320, and admission control, such as a connection establishment cause included in MsgA, allocation and retention priority (ARP), a quality of service (QOS) identifier, and configured network slices in each of the first and second cells.

The RAN, in step 7, indicates the determined serving cell to the UE 104 along with a random access response via a PDCCH and/or a physical downlink shared channel (PDSCH) for Message B (MsgB) delivery. In some cases, the UE 104 monitors a PDCCH search space associated with both the first cell 310 and the second cell 320. The corresponding PDCCH CORESET is quasi-co-located with a first SSB of the first cell selected for a RA preamble transmission.

In one example, DCI for MsgB delivery includes an indication of the serving cell for the UE 104. In another example, PDSCH for MsgB delivery (e.g., PDSCH payload, PDSCH demodulation reference signal (DM RS)) includes an indication of the serving cell for the UE 104. In another example, the UE 104 monitors both a first PDCCH search space associated with the first cell 310 and a second PDCCH search space associated with the second cell 320, where both first and second PDCCH search spaces are quasi-co-located with the first SSB of the first cell selected for the PRACH preamble transmission. The UE 104 identifies the serving cell based on a search space where the UE 104 detects a DCI format for MsgB delivery.

When the UE 104 identifies, after decoding the MsgB, the second cell 320 is assigned as a serving cell for the UE 104, the UE, in steps 8 and 9, starts detecting SS or a discovery signal of the second cell 320. The UE 104 may receive a PBCH of the second cell and/or essential system information (e.g., system information block type 1 (SIB1)) along with the SS or the discovery signal of the second cell 320.

When the UE 104 identifies a successful random access response (successRAR) MAC subPDU intended to the UE 104 in a MsgB, and when the UE 104 identifies a PCI in a MAC subheader of the successRAR MAC subPDU, the UE 104 determines that a cell indicated by the PCI is a serving cell. For example, the UE 104 is configured with multiple PDCCH search spaces, each associated with at least one candidate cell. The UE 104 starts to monitor a PDCCH search space associated with the cell indicated by the PCI upon successful decoding of MsgB and receives, in step 10, an RRC Setup (or Resume) message and/or transmits, in step 11, an RRC Setup (or Resume) Complete message.

In some embodiments, when the UE 104 initiates a 2-step random access procedure in the first cell 310 and the RAN sends an indication in a MsgB that the second cell 320 (e.g., a neighbor cell) is potentially assigned as a serving cell for the UE 104, the RAN also sends a corresponding fallback RAR (fallbackRAR), such as a fallback to the 4-step random access procedure, in the MsgB to the UE 104.

For example, when a MAC subheader with a PCI is followed by one or more consecutive MAC subPDUs for fallback RAR (e.g., each MAC subPDU including a MAC subheader with a RAPID and a fallbackRAR), a cell indicated by the PCI is associated with a set of PRACH preambles indicated by the one or more consecutive MAC subPDUs for fallback RAR. When a UE identifies a transmitted PRACH preamble and an associated PCI in a MsgB, the UE transmits a Msg3 in response to receiving the MsgB. In the Msg3, the UE includes a measurement report on a cell indicated by the associated PCI. Upon the first cell 310 receiving the Msg3, the RAN determines a serving cell for the UE between the first cell 310 and the second cell 320 and indicates the serving cell to the UE via Msg4 delivery.

In some embodiments, a MAC subheader (octet aligned) for MsgB includes one or more of the following fields:

E: The Extension field is a flag indicating if the MAC subPDU including this MAC subheader is the last MAC subPDU or not (other than MAC subPDU for MAC service data unit (SDU)) in the MAC PDU. The E field is set to 1 to indicate at least another MAC subPDU follows. The E field is set to 0 to indicate that the MAC subPDU including this MAC subheader is the last MAC subPDU (other than MAC subPDU for MAC SDU) in the MAC PDU;

T1: The Type1 field is a flag indicating whether the MAC subheader contains a Random Access Preamble ID or T2. The T1 field is set to 0 to indicate the presence of T2 field in the subheader. The T1 field is set to 1 to indicate the presence of a Random Access Preamble ID field in the subheader (RAPID);

T2: The Type2 field is a flag indicating whether the MAC subheader contains a Backoff Indicator or T3. The T2 field is set to 0 to indicate the presence of T3 field in the subheader. The T2 field is set to 1 to indicate the presence of a Backoff Indicator field in the subheader (BI);

T3: The Type3 field is a flag indicating whether the MAC subheader contains a MAC SDU indicator(S) or T4. The T3 field is set to 0 to indicate the presence of T4 field in the subheader. The T3 field is set to 1 to indicate the presence of a MAC SDU indicator field in the subheader(S);

T4: The Type4 field is a flag indicating whether the MAC subheader contains a Physical Cell Identity (PCI) only or contains a MAC SDU indicator (S) and a Physical Cell Identity (PCI). The T4 field is set to 0 to indicate the presence of S field and a Physical Cell Identity field in the subheader. The T4 field is set to 1 to indicate the presence of a Physical Cell Identity field only in the subheader (PCI only);

S: This field indicates whether ‘MAC subPDU(s) for MAC SDU’ follow the MAC subPDU including this MAC subheader or not; The S field is set to 1 to indicate presence of ‘MAC subPDU(s) for MAC SDU’. The S field is set to 0 to indicate absence of ‘MAC subPDU(s) for MAC SDU’;

R: Reserved bit, set to 0;

BI: The Backoff Indicator field identifies the overload condition in the cell. The size of the BI field is 4 bits;

PCI: The Physical Cell Identity field identifies a neighbor cell assigned as a serving cell (in MAC subPDU for success RAR) or assigned as a candidate serving cell (in MAC subPDU for PCI only). The size of the PCI field is 10 bits; and/or

RAPID: The Random Access Preamble IDentifier field identifies the transmitted Random Access Preamble. The size of the RAPID field is 6 bits. If the RAPID in the MAC subheader of a MAC subPDU corresponds to one of the Random Access Preambles configured for system information (SI) request, MAC RAR is not included in the MAC subPDU.

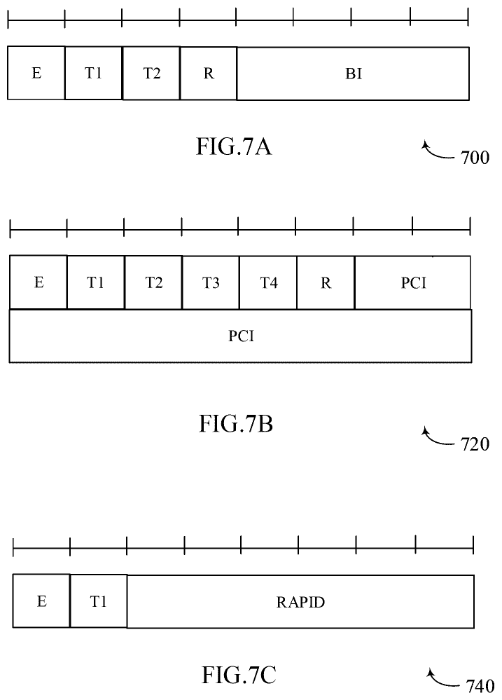

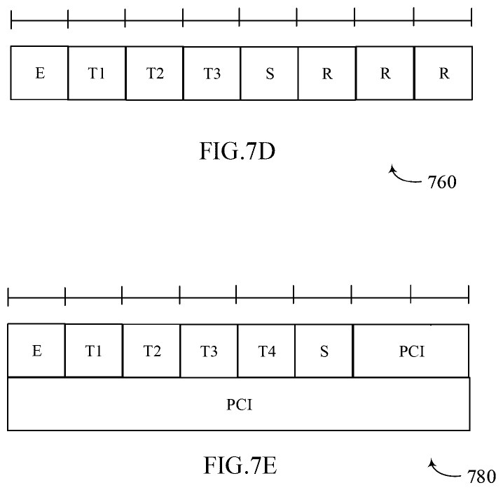

FIGS. 7A-7E illustrate example medium access channel (MAC) subheader types in accordance with aspects of the present disclosure. For example, FIG. 7A depicts a MAC subheader 700 with BI only. The subheader 700 may only be placed at a beginning of a MAC PDU, when included.

Further, FIG. 7B depicts a MAC subheader 720 with PCI only, FIG. 7C depicts a MAC subheader 740 with RAPID for fallbackRAR, FIG. 7D depicts a MAC subheader 760 for successRAR, and FIG. 7E depicts a MAC subheader 780 with PCI for successRAR.

A MsgB MAC PDU may also include a MAC subheader with logical channel identity (LCID) and MAC SDU for common control channel (CCCH), dedicated control channel (DCCH), or dedicated traffic channel (DTCH), and/or a MAC subheader with LCID and padding.

In some cases, at most one MAC subPDU for successRAR, indicating a presence of MAC subPDU(s) for MAC SDU is included in a MAC PDU. The MAC subPDU(s) for MAC SDU are placed immediately after the MAC subPDU for successRAR, indicating a presence of MAC subPDU(s) for MAC SDU. When the MAC PDU includes MAC subPDU(s) for MAC SDU, the last MAC subPDU for MAC SDU is placed before MAC subPDU with padding. Otherwise, the last MAC subPDU in MAC PDU is placed before padding. The MAC subPDU with padding may use a R/R/LCID MAC subheader. The size of padding in the MAC subPDU with padding can be zero. The length of padding is implicit and based on a TB size, a size of MAC subPDU(s), and so on.

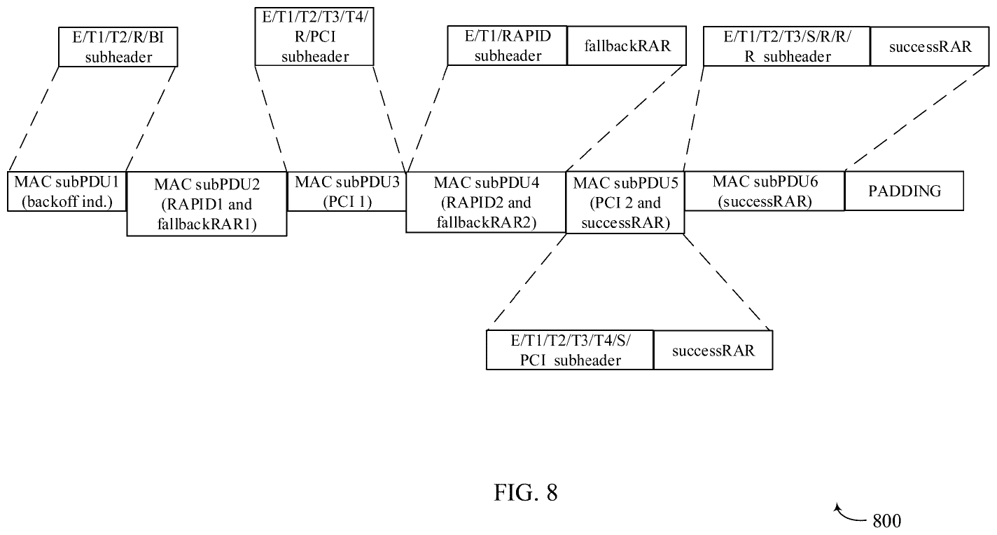

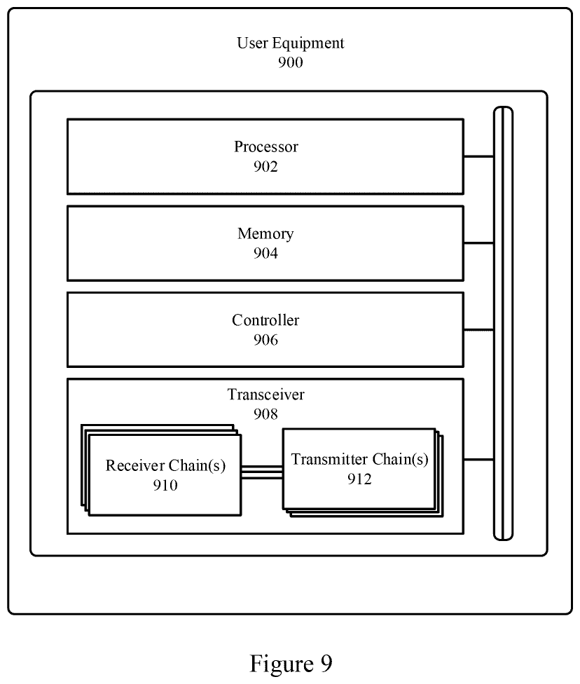

FIG. 8 illustrates an example message MAC Protocol Data Unit (PDU) with Physical Cell Identities (PCIs) 800 in accordance with aspects of the present disclosure. When the UE 104 transmits a PRACH preamble with RAPID 1 and a corresponding MsgA PUSCH 1 in the first cell 310, the UE 104 assumes, based on the MAC subPDU2, there is no neighbor cell associated with RAPID 1 and fallbacks to a 4-step random access procedure in the first cell 310.

When the UE 104 transmits a PRACH preamble with RAPID 2 and a corresponding MagA PUSCH 2 in the first cell 310, the UE 104 assumes, based on the MAC subPDU3 and MAC subPDU4, a cell of PCI 1 is a candidate neighbor cell and performs cell detection and measurement for the cell of PCI 1. When the UE 104 transmits a PRACH preamble of RAPID 3 and a corresponding MsgA PUSCH 3 in the first cell 310 and if the UE 104 identifies a UE contention resolution identity in the MAC subPDU5 of the MsgB, the UE 104 assumes that a cell of PCI 2 is a serving cell and starts to monitor PDCCH in the cell of PCI 2.

When the UE 104 transmits a PRACH preamble of RAPID 4 and a corresponding MsgA PUSCH 4 in the first cell 310 and if the UE 104 identifies the UE contention resolution identity in the MAC subPDU6 of the MsgB, the UE 104 assumes that the first cell 310 is a serving cell and starts to monitor PDCCH in the first cell 310.

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to support a means for transmitting a PRACH preamble on a PRACH occasion of a first cell and a corresponding message A (MsgA) PUSCH on a MsgA PUSCH occasion of the first cell, receiving a message B (MsgB) that includes a random access response, identifying a serving cell based on receiving the MsgB, and transmitting a connection complete message to the identified serving cell.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receive the signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

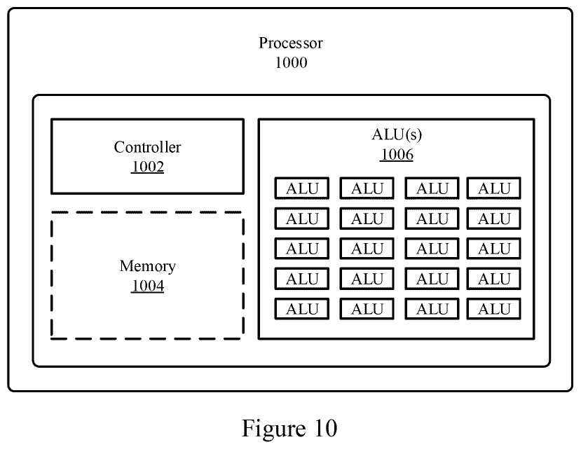

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support a means for transmitting a PRACH preamble on a PRACH occasion of a first cell and a corresponding message A (MsgA) PUSCH on a MsgA PUSCH occasion of the first cell, receiving a message B (MsgB) that includes a random access response, identifying a serving cell based on receiving the MsgB, and transmitting a connection complete message to the identified serving cell.

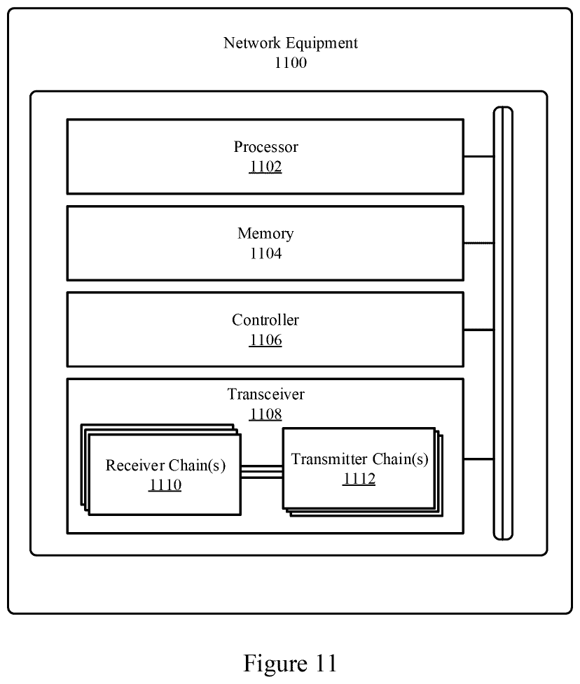

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to support a means for receiving, from a UE, a PRACH preamble on a PRACH occasion of a first cell and a corresponding message A (MsgA) PUSCH on a MsgA PUSCH occasion of the first cell, and transmitting a message B (MsgB) that includes a random access response, wherein delivery of the MsgB identifies a neighbor cell of the first cell as a serving cell for the UE.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

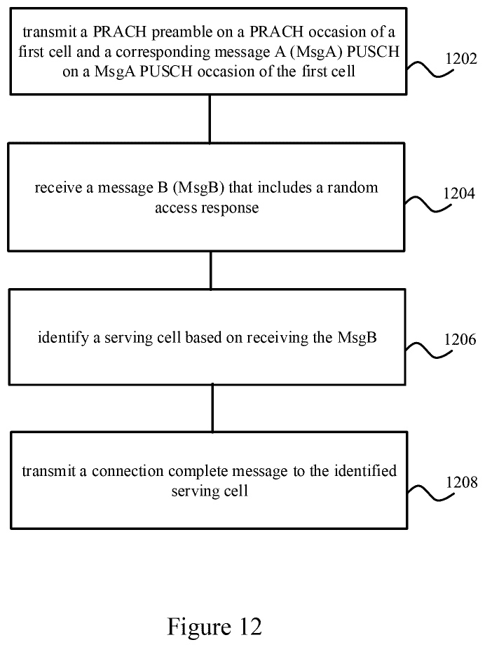

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions.

At 1202, the method may include transmitting a PRACH preamble on a PRACH occasion of a first cell and a corresponding message A (MsgA) PUSCH on a MsgA PUSCH occasion of the first cell. The operations of 1202 may be performed in accordance with examples as described herein. In some implementations, aspects of the operations of 1202 may be performed by a UE as described with reference to FIG. 9.

At 1204, the method may include receiving a message B (MsgB) that includes a random access response. The operations of 1204 may be performed in accordance with examples as described herein. In some implementations, aspects of the operations of 1204 may be performed a UE as described with reference to FIG. 9.

At 1206, the method may include identifying a serving cell based on receiving the MsgB. The operations of 1206 may be performed in accordance with examples as described herein. In some implementations, aspects of the operations of 1206 may be performed a UE as described with reference to FIG. 9.

At 1208, the method may include transmitting a connection complete message to the identified serving cell. The operations of 1208 may be performed in accordance with examples as described herein. In some implementations, aspects of the operations of 1208 may be performed a UE as described with reference to FIG. 9.

It should be noted that the method described herein describes a possible implementation, and that the operations and the steps may be rearranged or otherwise modified and that other implementations are possible.

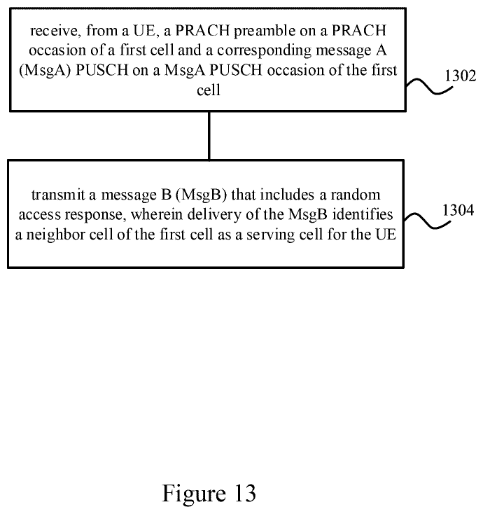

FIG. 13 illustrates a flowchart of a method 1300 in accordance with aspects of the present disclosure. The operations of the method may be implemented by a NE as described herein. In some implementations, the NE may execute a set of instructions to control the function elements of the NE to perform the described functions.

At 1302, the method may include receiving, from a UE, a PRACH preamble on a PRACH occasion of a first cell and a corresponding message A (MsgA) PUSCH on a MsgA PUSCH occasion of the first cell. The operations of 1302 may be performed in accordance with examples as described herein. In some implementations, aspects of the operations of 1002 may be performed by a NE as described with reference to FIG. 11.

At 1304, the method may include transmitting a message B (MsgB) that includes a random access response, wherein delivery of the MsgB identifies a neighbor cell of the first cell as a serving cell for the UE. The operations of 1304 may be performed in accordance with examples as described herein. In some implementations, aspects of the operations of 1304 may be performed by a NE as described with reference to FIG. 11.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit a physical random access channel (PRACH) preamble on a PRACH occasion of a first cell and a corresponding message A (MsgA) physical uplink shared channel (PUSCH) on a MsgA PUSCH occasion of the first cell;
receive a message B (MsgB) that includes a random access response;
identify a serving cell based on receiving the MsgB; and
transmit a connection complete message to the identified serving cell.

2. The UE of claim 1, wherein the connection complete message is a connection setup complete message or a connection resume complete message.

3. The UE of claim 1, wherein the at least one processor is further configured to cause the UE to:
detect the first cell;
select the first cell; and
monitor system information of the first cell.

4. The UE of claim 1, wherein the serving cell is different from the first cell and transitions from an energy saving state of operation to an active state of operation.

5. The UE of claim 1, wherein the at least one processor is further configured to cause the UE to:
perform cell detection for the serving cell when the serving cell is different from the first cell.

6. The UE of claim 1, wherein the at least one processor is further configured to cause the UE to:
receive a configuration of multiple common physical downlink control channel (PDCCH) search spaces,
wherein each common PDCCH search space is associated with at least one cell from the first cell and one or more neighbor cells of the first cell.

7. The UE of claim 6, wherein the at least one processor is further configured to cause the UE to:
monitor the multiple common PDCCH search spaces to receive the MsgB; and
identify the serving cell based on detecting downlink control information (DCI) for MsgB delivery in a common PDCCH search space of the multiple common PDCCH search spaces.

8. The UE of claim 6, wherein the at least one processor is further configured to cause the UE to:
monitor a first common PDCCH search space of the multiple common PDCCH search spaces that is associated with the first cell.

9. The UE of claim 8, wherein:
the UE identifies the first cell as the serving cell when the MsgB does not include an indication of the serving cell corresponding to the random access response; and
the UE identifies a second cell different from the first cell as the serving cell when the MsgB includes an indication of the second cell as the serving cell corresponding to the random access response.

10. The UE of claim 9, wherein the indication of the second cell as the serving cell is included in a medium access control (MAC) subheader of a MAC sub packet data unit (subPDU) for the random access response.

11. The UE of claim 6, wherein the at least one processor is further configured to cause the UE to:
monitor a common PDCCH search space associated with the serving cell upon identifying the serving cell; and
receive, within the monitored common PDCCH search space, an uplink grant to transmit the connection complete message.

12. The UE of claim 6, wherein the multiple PDCCH search spaces are quasi co-located with a synchronization signal block (SSB),
wherein the SSB is selected for the PRACH preamble transmission on the PRACH occasion of the first cell.

13. The UE of claim 6, wherein the first cell and the one or more neighbor cells are deployed in a same frequency layer.

14. The UE of claim 6, wherein the first cell and the one or more neighbor cells are deployed in different frequency layers.

15. The UE of claim 1, wherein the random access response included in the MsgB is a success random access response (successRAR).

16. The UE of claim 1, wherein, when the random access response included in the MsgB is a fallback random access response (fallbackRAR) and the MsgB includes an indication of one or more candidate serving cells corresponding to the fallbackRAR, the processor is further configured to cause the UE to:
transmit a message 3 (Msg3) with a measurement report for the one or more candidate serving cells;
receive a message 4 (Msg4); and
identify the serving cell based on the reception of the MsgB and the Msg4.

17. A processor for wireless communication, comprising:
at least one controller coupled with at least one memory and configured to cause the processor to:
transmit a physical random access channel (PRACH) preamble on a PRACH occasion of a first cell and a corresponding message A (MsgA) physical uplink shared channel (PUSCH) on a MsgA PUSCH occasion of the first cell;
receive a message B (MsgB) that includes a random access response;
identify a serving cell based on receiving the MsgB; and
transmit a connection complete message to the identified serving cell.

18. A method performed by a user equipment (UE), the method comprising:
transmitting a physical random access channel (PRACH) preamble on a PRACH occasion of a first cell and a corresponding message A (MsgA) physical uplink shared channel (PUSCH) on a MsgA PUSCH occasion of the first cell;
receiving a message B (MsgB) that includes a random access response;
identifying a serving cell based on receiving the MsgB; and
transmitting a connection complete message to the identified serving cell.

19. A network entity for wireless communication, comprising:
at least one memory; and
at least one processor coupled with the at least one memory and configured to cause the network entity to:
receive, from a user equipment (UE), a physical random access channel (PRACH) preamble on a PRACH occasion of a first cell and a corresponding message A (MsgA) physical uplink shared channel (PUSCH) on a MsgA PUSCH occasion of the first cell; and
transmit a message B (MsgB) that includes a random access response, wherein delivery of the MsgB identifies a neighbor cell of the first cell as a serving cell for the UE.

20. The network entity of claim 19, wherein a common physical downlink control channel (PDCCH) search space that includes downlink control information (DCI) for the delivery of the MsgB identifies the neighbor cell of the first cell as the serving cell for the UE.
